(19) United States
(12) Patent Application Publication
(10) Pub. No.: US 2013/0246948 A1
(43) Pub. Date: Sep. 19, 2013

(54) CONTROL METHOD AND CONTROL DEVICE

(71) Applicant: LENOVO (BEIJING) CO., LTD., Beijing (CN)

(72) Inventors: Dong Chen, Beijing (CN); Guang Yang, Beijing (CN)

(73) Assignee: LENOVO (BEIJING) CO., LTD., Beijing (CN)

(21) Appl. No.: 13/844,867

(22) Filed: Mar. 16, 2013

(30) Foreign Application Priority Data
Mar. 16, 2012 (CN) 201210071603.1

(51) Int. Cl. G06F 3/01

(52) U.S. Cl. CPC G06F 3/017
USPC 715/764

(57) ABSTRACT

A control method and control device applied to an electronic apparatus having a touch screen display and executing a file are illustrated in the present invention. The control method comprises determining whether content in the file is being displayed on the display screen; determining a displaying portion for displaying the file on the display screen, when the content in the file is being displayed on the display screen; detecting a gesture information, which comprises the number of contact points of hands with the displaying portion and a movement information of the contact points, at an arbitrary position in the displaying portion; and adjusting the content in the file according to the gesture information. In the control method and control device, according to the present invention, the displaying of the files can be controlled exactly and conveniently according to the user's intention, and the usage experiences of the user are improved efficiently.

### CROSS REFERENCE TO RELATED APPLICATIONS

This application claims the benefit under 35 U.S.C. §119(a) of Chinese Patent Application No. 201210071603.1, filed on Mar. 16, 2012, the entire disclosure of which is incorporated herein by references for all purposes.

### TECHNICAL FIELD

The present application relates to an electronic technique field and in particular, to a control method and a control device for an electronic apparatus.

### BACKGROUND

With the development of the electronic technique, various types of electronic apparatus have arisen, for example, a computer, a TV, a game machine, a communication terminal, personal digital assistant, etc. The electronic apparatus can play various contents such as video, game, music, text and the like thereon, so that users may use the electronic apparatus as entertainment.

During a process of executing the content on the electronic apparatus, a play progress bar is provided on a play interface generally to control a play progress of the content. However, it is difficult to control the played content accurately. For example, an offset amount of a video play progress bar on a video play interface is calculated according to the playing time of the entire video, when the video is viewed with an apparatus having a touch screen, such as a tablet computer or a mobile communication terminal. If the play progress bar is moved when playing a long movie, the play progress of the video moves forward or backward, so it is difficult to control the play progress of the video exactly according to the user's intention. Furthermore, for presentation files such as a text file, a web page, etc., a scale factor of the presentation file needs to be adjusted suitably to make the best use of the display screen, and a playing position of the presentation file may be changed to display a part of the content that the user desires to view. Therefore, a solution is required for playing the files exactly and conveniently, according to the user's intention.

### SUMMARY

Embodiments of the present invention provide a control method and a control device for an electronic apparatus, which are capable of controlling the displaying of files exactly and conveniently according to the user's intention and thus, improving the user's experience.

On the one hand, a control method is applied to an electronic apparatus having a touch screen display and executing a file, the control method comprising determining whether content in the file is being displayed on the display screen; determining a displaying portion for displaying the file on the display screen when the content in the file is being displayed on the display screen; detecting at an arbitrary position in the displaying portion a gesture information, which comprises a number of contact points of hands with the displaying portion and a movement information of the contact points; and adjusting the content in the file according to the gesture information.

On the other hand, a control device is applied to an electronic apparatus having a touch screen display and executing a file, the control device comprising a determination unit for determining whether content in the file is being displayed on the display screen and determining a displaying portion for displaying the file on the display screen when the content in the file is being displayed on the display screen; a detection unit for detecting at an arbitrary position in the displaying portion a gesture information, which comprises a number of contact points of hands with the displaying portion and a movement information of the contact points; and a control unit for adjusting the content in the file according to the gesture information.

In the controlling scheme for the electronic apparatus, according to the embodiments of the present invention, the displaying of the content of files in the electronic apparatus is controlled by the gesture information, so that the displaying of the files can be controlled exactly and conveniently according to the user's intention, and the usage experience of the user is improved efficiently.

### BRIEF DESCRIPTION OF THE DRAWINGS

The present invention will become more fully understood from the detailed description given hereinafter and the accompanying drawings used when describing the embodiments or prior art, which are given by way of illustration only and thus, are not limitative of the present invention. Those skilled in the art can obtain other drawings according to the drawings shown herein without inventive labors.

FIG. 1 is a flow chart illustrating a control method for an electronic apparatus according to the embodiments of the present invention.

FIG. 2 is a flow chart illustrating a first implementation of an adjustment operation in the control method according to the embodiments of the present invention.

FIG. 3 is a flow chart illustrating a second implementation of the adjustment operation in the control method according to the embodiments of the present invention.

FIG. 4 is a block diagram illustrating a control device according to another embodiment of the present invention.

### DETAILED DESCRIPTION

Thereafter, the solutions will be described, according to the embodiments of the present invention, clearly and fully in connection with the drawings in the embodiments of the present invention. Obviously, the embodiments described are only part of the embodiments of the present invention as opposed to all of the embodiments of the present invention.

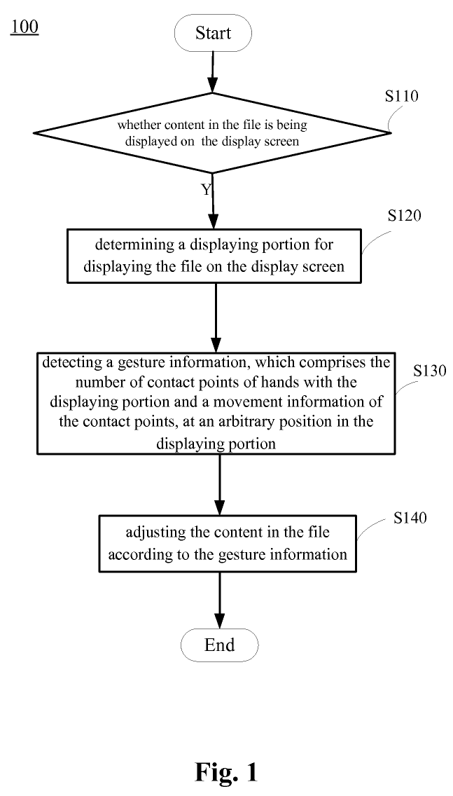

FIG. 1 is a flow chart illustrating a control method 100 for an electronic apparatus, according to the embodiments of the present invention. The control method 100 is applicable to any electronic apparatus having a touch screen display (also referred to as “touchscreen”), for example, a personal digital assistant, a game machine, a communication terminal, and the like. The touch screen display may respond to touch operations made by objects, such as figures, electrical pens, etc. The types of the electronic apparatus do not limit the present disclosure, as long as the electronic apparatus has the touch screen display. The electronic apparatus may execute various files, such as a video file, an audio file, a text file, a picture, a web page, a game, etc., and it may control the displaying of these files by touch operations on the touch screen display.

The control method 100 may comprise determining whether content in the file is being displayed on the display screen (step S110); determining a displaying portion for displaying the file on the display screen when the content in the file is being displayed on the display screen (step S120); detecting at an arbitrary position in the displaying portion a gesture information, which comprises a number of contact points of hands with the displaying portion and a movement of information of the contact points (step S130); and adjusting the content in the file according to the gesture information (step S140).

In step S110, it is determined whether the content in the file is being displayed on the display screen. It may be known that the content in the file is being displayed on the display screen by detecting an open operation of the file, and it may be known that the content in the file is not being displayed on the display screen by detecting a close operation of the file. The open operations and close operations may be recorded in real-time to determine whether the content in the file is being displayed on the display screen, so that a controlling of a file displaying may be implemented by a touch operation on the touch screen display. Furthermore, it may determine whether the content in the file is being displayed on the display screen by information about applications being executed in the electronic apparatus. Of course, engineers and technicians may utilize any suitable manner to determine whether the content in the file is being displayed on the display screen according to personal preferences or actual requirements in practice, and the determination manner does not limit the present disclosure.

In step S120, a displaying portion for displaying the file on the display screen is determined when the content in the file is being displayed on the display screen. A plurality of files may be displayed in the electronic apparatus simultaneously, and different files may be displayed at different portions of the display screen. For example, the user may further open a text file or a picture to perform an uploading or downloading of the file while he/she views a web page. Once the displaying portion for displaying the file on the display screen is determined, the control of the corresponding file may be performed by touch operations on the displaying portion corresponding to the file.

In step S130, gesture information is detected at an arbitrary position, which comprises the number of contact points of hands with the displaying portion and the movement information of the contact points. Herein, the gesture information is considered as information on the displaying portion as long as a starting position of the contact point is at the displaying portion, no matter whether the contact point is on the displaying portion all the way.

The gesture information on the displaying portion corresponds to a file, which is desired to control its displaying. The gesture information may be generated by the touch operation(s) made by hands on the touch screen display, or by the touch operation made by other parts of the human body instead of the hand on the touch screen display, or further by the touch operation made by an electronic pen on the touch screen display. Accordingly, the contact points with the displaying portion may be generated by the touch operation between any part of the human body or an electronic pen and the displaying portion. That is, the gesture information can be touch information on the displaying portion made by any body part capable of acting as the hands; the body part is not limited to the hands. In a case where the gesture information is generated by the touch operation on the displaying portion made by the electronic pen, the contact point refers to a contact point on the displaying portion by the electronic pen manipulated by the user. The gesture information may comprise of the number of the contact points and the movement information of the contact point. Further, the gesture information may also comprise other information such as a click information, a double-click information, and a rotate information, etc.

In step S140, the content in the file is adjusted according to the gesture information. As described previously, the gesture information comprises the number of the contact points with the displaying portion by the hand and the movement information of the contact points. That is, the content in the file is adjusted according to the number of the contact points with the displaying portion by the hand and the movement information of the contact points. In particular, a displaying position, fast forwarding, rewinding, slow motion playing, zooming in, zooming out, etc. of the content in the file may be adjusted. It should be noted that the content in the file might be further adjusted according to only at least one of the numbers of the contact points with the displaying portion by the hand and the movement information of the contact points.

In the above control method for the electronic apparatus, according to the embodiments of the present invention, the displaying of the file content is controlled according to the number of the contact points with the displaying portion by the hand and the movement information of the contact points, so that the displaying of the files can be controlled exactly and conveniently according to the user's intention. The usage experiences of the user are improved efficiently.

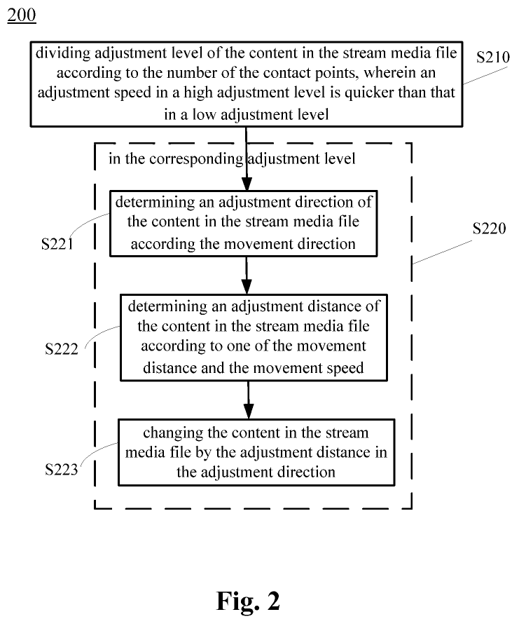

FIG. 2 is a flow chart illustrating the first implementation of an adjustment operation in the control method, according to the embodiments of the present invention. Step S140 illustrates how to adjust the content in the file according to the gesture information, which is described in details below, taking stream media files such as a video file, an audio file, and a Flash file as an example.

The step of adjusting the content in the file according to the gesture information may comprise dividing adjustment levels of the content in the stream media file according to the number of contact points, wherein an adjustment speed in a high adjustment level is quicker than that in a low adjustment level (step S210); adjusting the content in the stream media file according to the movement information in the adjustment level corresponding to the number of contact points (step S220).

In step S210, the adjustment level of the content in the stream media file may be divided according to a manner where the adjustment level ascends or descends as increasing of the number of contact points. For example, Table 1 shows a stream media file having a playing time of 60 minutes. When the number of contact points with the touch screen display by the hand is one, the adjustment level of the content in the stream media file is L1, and the stream media file may change its playing time by at most one minute from a current playing position. When the number of contact points with the touch screen display by the hand is two, the adjustment level of the content in the stream media file is L2, and the stream media file may change its playing time by at most 10 minutes from the current playing position. When the number of contact points with the touch screen display by the hand is three, the adjustment level of the content in the stream media file is L3, and the stream media file may change its playing time by at most 30 minutes from the current playing position. When the number of contact points with the touch screen display by the hand is four, the adjustment level of the content in the stream media file is L4, and the stream media file may change its playing time by at most 60 minutes from the current playing position. In the adjustment level L1, the adjustment speed of the stream media file is set to slowest, and a maximum change amount of its playing time is minimum one minute, which may be a fine adjustment for the stream media file. In the adjustment level L4, the adjustment speed of the stream media file is set to quickest, and the maximum change amount of its playing time is 60 minutes, which may create a rapid adjustment for the playing portion of the stream media file. By using different adjustment levels, according to the number of the contact points, a quick adjustment or a slow adjustment of the stream media file may be controlled, so that the displaying of the stream media file can be controlled exactly and conveniently. Furthermore, for example, when the number of contact points is five, the stream media file may be controlled to be played in slow motion, thus a specified play controlling operation may be realized.

TABLE 1

| Number of the Contact | | Maximum Time Change |
|---|---|---|
| Point(s) | Adjustment Level | Amount of File |
| 1 | L1 | 1 minute |
| 2 | L2 | 10 minutes |
| 3 | L3 | 30 minutes |
| 4 | L4 | 60 minutes |

Please note that the adjustment speed in the high adjustment level may be set as slower than that in the low adjustment level. Alternatively, the adjustment level of the content in the stream media file may be divided according to a manner where the adjustment level descends as increasing from the number of the contact points. Additionally, the values of the maximum time change amount of the stream media file is only exemplary, and those skilled in the art may set it according to at least one of the total playing time of the stream media file and the user's intention.

In step S220, as for the adjustment level corresponding to the number of the contact points, the content in the stream media file is adjusted according to the movement information. The movement information may comprise a movement direction, a movement distance, and a movement speed. As illustrated by the dotted block in FIG. 2, the step of adjusting the content in the stream media file, according to the movement information, may comprise determining an adjustment direction of the content in the stream media file, according the movement direction in step S221; determining an adjustment distance of the content in the stream media file, according to one of the movement distance and the movement speed in step S222; and changing the content in the stream media file by the adjustment distance in the adjustment direction in step S223.

As an example, if the movement direction of the contact point is same or substantively the same as the forward direction of the play progress bar of the stream media file, it is determined to perform a fast forward adjustment on the stream media file; if the movement direction of the contact point is same or substantively the same as a backward direction of the play progress bar of the stream media file, it is determined to perform a rewind adjustment on the stream media file. The meaning of the term “substantively same” is explained as follows. Since the movement direction of the hand on the display screen may change and the movement direction of the contact point by the hand with the display screen is difficult to be controlled exactly, therefore the movement direction of the contact point is difficult to be strictly same as the forward direction of the play progress bar of the stream media file. Thus, the movement direction of the contact point may be judged as being the same as the forward direction of the play progress bar of the stream media file when the two are substantively the same (for example, a included angle between them is less than 45°).

Furthermore, in the adjustment level corresponding to the number of contact points, the adjustment distance of the content in the stream media file is determined according to the movement distance or the movement speed in step S222. For example, in a case of the adjustment level L1 corresponding to one contact point, since the maximum time change amount of the stream media file is one minute, it is determined that the adjustment distance of the content in the stream media file is the playing time of 30 seconds (half of one minute), if the movement distance of the contact point is half of a total length of the displaying portion (or the display screen) of the file. After determining the adjustment direction and the adjustment distance, the content in the stream media file is changed by the adjustment distance in the adjustment direction in step S223. Engineers and technicians may utilize any other suitable manner to determine the adjustment distance based on their requirements.

It may know from the above description with reference to FIG. 2, because the playing of the content in the stream media file is controlled according to the number of the contact points by the hands with the displaying portion and the movement information of the contact point, the displaying of the files can be controlled exactly and conveniently according to the user's intention, and the usage experiences of the user is improved efficiently.

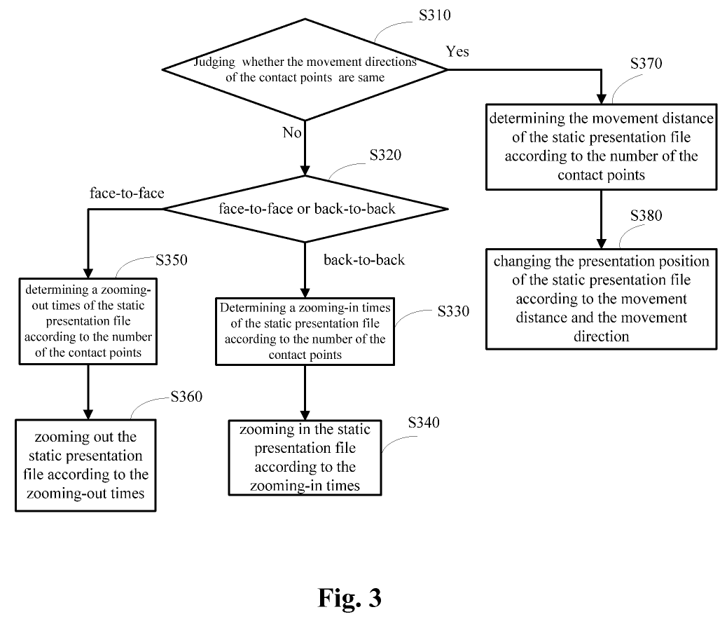

FIG. 3 is a flow chart illustrating a second implementation of the adjustment operation in the control method, according to the embodiments of the present invention. In the second implementation, the number of the contact points by the hand with the displaying portion is at least two and the movement information of the contact point comprises the movement direction of the contact point, taken static presentation files as example. The static presentation file comprises a picture, a web page, a text file such as Word file, Txt file, etc., and may also be any other files other than a continue media stream file which is played in a time order.

In the process of adjusting the content in the file according to the gesture information in step S140, it is judged firstly whether the movement directions of the contact points by hands with the displaying portion are same in step S310, and a zooming of the static presentation file is adjusted when the contact points having different movement directions exist among the contact points (NO in step S310), while a presentation position of the static presentation file is adjusted when the movement direction of all of the contact points are same (YES in step S310).

As a detailed implementation for adjusting the zooming of the static presentation file, it may judge whether the contact points having different movement directions move face-to-face or back-to-back (step S320), and the static presentation file is zoomed out when the contact points having different movement directions move face-to-face, while the static presentation file is zoomed in when the contact points having different movement directions move back-to-back. In particularly, a zooming-in times of the static presentation file is determined according to the number of the contact points when the contact points having different movement directions move back-to-back (step S330), and the static presentation file is zoomed in according to the zooming-in times (step S340); a zooming-out times of the static presentation file is determined according to the number of the contact points when the contact points having different movement directions move face-to-face (step S350), and the static presentation file is zoomed out according to the zooming-out times (step S360).

As a detailed implementation for adjusting the presentation position of the static presentation file, the movement distance of the static presentation file may be determined according to the number of the contact points (step S370), and then the presentation position of the static presentation file is changed according to the movement distance (step S380).

It should note that, in the judging “whether the movement directions are same” and “whether the contact points move face-to-face or back-to-back”, the judgments are only rough judgments since the controlling made by a man is difficult to achieve a strict same or opposite movement directions of the contact points. For example, in a process that all of the contact points by hands with the displaying portion slid from left to right, it is judged that the movement directions of the contact points are same even when a slide track of the contact point renders a curve, or even if there is a certain included corner (for example, 20°, 40°, etc.) among the slide directions of the different contact points. It is judged that the movement directions of the contact points are different when the different contact points move in completely different directions (for example, one contact point move leftward while another contact point moves rightward). In practice, those skilled in the art may judge according to movement features of the respective fingers of the hand when they move on the touch screen display.

Following descriptions are exemplary and take a controlling of picture playback as an example. It is assumed that three fingers move on the displaying portion of a picture, a zooming corresponding to the three fingers is zooming in of 20% or zooming out of 20%, and a movement distance corresponding to the three fingers is 50% of the picture. If all of the movement directions of the contact points by the three fingers on the displaying portion are same, the picture is moved by a distance of half of its size in the movement direction of the contact point. If not all of the movement directions of the contact points by the three fingers on the displaying portion are same, it may further judge whether the contact points having different movement directions move face-to-face or back-to-back. The picture is zoomed in by 20% when the contact points having different movement directions move back-to-back; and the picture is zoomed out by 20% when the contact points having different movement directions move face-to-face. In practice, the engineers and technicians may variously set a relationship between the number of the contact points and the movement distance or the zoom ratio.

FIG. 3 is only the exemplary embodiment for adjusting the content in the static presentation file according to the gesture information. The content in the static presentation file may be adjusted in other manners alternatively. For example, dividing adjustment level of the content in the static presentation file according to the number of the contact points, wherein an adjustment speed in a high adjustment level is quicker than that in a low adjustment level; adjusting the presentation position of the static presentation file according to the movement information of the contact points in the adjustment level corresponding to the number of the contact points. The movement information may comprise movement speed and movement direction, and may alternatively comprise movement distance and movement direction.

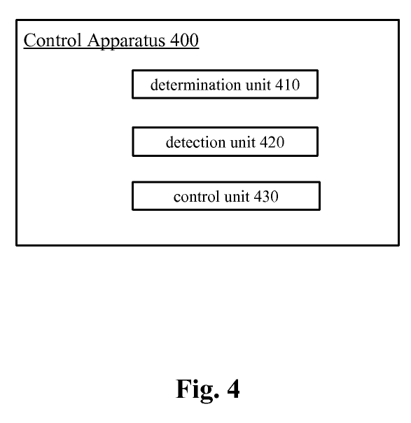

FIG. 4 is a block diagram illustrating a control device 400 according to another embodiment of the present invention. The control device 400 may be applied to any electronic apparatus having a touch screen display. The touch screen display may response to touch operations made by fingers, electronic pen and the like. The electronic apparatus may display various files.

The control device 400 comprises a determination unit 410 for determining whether content in the file is being displayed on the display screen, and determining a displaying portion for displaying the file on the display screen when the content in the file is being displayed on the display screen; a detection unit 420 for detecting at an arbitrary position in the displaying portion a gesture information, which comprises a number of contact points of hands with the displaying portion and a movement information of the contact points; and a control unit 430 for adjusting the content in the file according to the gesture information.

The determination unit 410 may determine whether the content in the file is being displayed on the display screen by detecting an open operation and a close operation of the file, or may determine whether the content in the file is being displayed on the display screen by information of applications being executed in the electronic apparatus. When it is determined that the content in the file is being displayed on the display screen, the determination unit 410 may further determine the displaying portion for displaying the file on the display screen, so that a controlling of a file displaying may be implemented by a touch operation on the touch screen display. In practice, the engineers and technicians may utilize any suitable manner to determine whether the content in the file is being displayed on the display screen according to personal preferences or actual requirements in practice, and the details of the determination manner would not limit the present disclosure.

The detection unit 420 detects the gesture information on the displaying portion corresponding to a file, which is desired to control its displaying, for such file. The gesture information can be touch information on the displaying portion made by any body parts capable of acting as the hands, and the body parts are not limited to the hands. The gesture information may comprise the number of the contact points and movement information of the contact point. Moreover, the gesture information is considered as information on the displaying portion as long as a start position of the contact point is at the displaying portion, no matter whether the contact point is on the displaying portion all the way. Furthermore, the gesture information may also comprise other information such as a click information, a double-click information, a rotate information, etc.

The control unit 430 adjusts the content in the file according to the number of the contact points with the displaying portion by the hand and the movement information of the contact points. In particular, a displaying position, fast forwarding, rewinding, slow motion playing, zooming in, zooming out, etc. of the content in the file may be adjusted, so that a diversified and exact controlling of the file displaying is realized. Please note that the content in the file may be further adjusted according to only at least one of the number of the contact points with the displaying portion by the hand and the movement information of the contact points.

In the above control device for the electronic apparatus, according to the embodiments of the present invention, the displaying of the file content is controlled according to the number of the contact points with the displaying portion by the hand and the movement information of the contact points, so that the displaying of the files can be controlled exactly and conveniently according to the user's intention and the usage experiences of the user is improved efficiently.

Thereafter will describe the operations and implementations of the control unit 430 in connection with the stream media file and the static presentation file.

Take a controlling of the stream media file as an example, the control unit 430 may comprise a dividing section for dividing adjustment level of the content in the stream media file according to the number of the contact points, wherein an adjustment speed in a high adjustment level is quicker than that in a low adjustment level; and an adjustment section for adjusting the content in the stream media file according to the movement information in the adjustment level corresponding to the number of the contact points. In particular, the dividing section may divide the adjustment level of the content in the stream media file according to a manner where the adjustment level ascends or descends as increasing of the number of the contact points. In the adjustment level corresponding to the number of the contact points, the adjustment section may adjust the content in the stream media file according to the movement information as follows: determining an adjustment direction of the content in the stream media file according the movement direction in the movement information; determining an adjustment distance of the content in the stream media file according to the movement distance or the movement speed in the movement information; and changing the content in the stream media file by the adjustment distance in the adjustment direction. The descriptions above in connection with FIG. 2 can be referred to for the detailed operations of the dividing section and the adjustment section.

Furthermore, the control unit 430 may also control a zooming and a presentation position of the file displayed according to the gesture information. Herein, the description is made by taken the above static presentation file as an example. The detection unit 420 detects that the number of the contact points by the hand with the displaying portion is at least two and the movement directions of the contact points. At this time, the control unit 430 comprises a judgment section for judging whether the movement directions of the contact points are same; a first adjustment section for adjusting the presentation position of the static presentation file when the movement direction of all of the contact points are same; and a second adjustment section for adjusting the zooming of the static presentation file when the contact points having different movement directions exist among the contact points. When the movement direction of all of the contact points are same, the first adjustment section adjust the presentation position of the static presentation file as follows: determining the movement distance of the static presentation file according to the number of the contact points; and changing the presentation position of the static presentation file according to the movement distance. When the contact points having different movement directions exist among the contact points, the adjustment section may further judge whether the contact points having different movement directions move face-to-face or back-to-back, and the second adjustment section may adjust the zooming of the static presentation file as follows: determining a zooming-out times of the static presentation file according to the number of the contact points when the contact points having different movement directions move face-to-face, and zooming out the static presentation file according to the zooming-out times; and determining a zooming-in times of the static presentation file according to the number of the contact points when the contact points having different movement directions move back-to-back, and zooming in the static presentation file according to the zooming-in times. As for further detailed operations of the control unit 430 in this case, the descriptions above in connection with FIG. 3 can be referred.

Alternatively, the content in the static presentation file may be adjusted in other manners. For example, dividing adjustment level of the content in the static presentation file according to the number of the contact points; in the adjustment level corresponding to the number of the contact points, adjusting the presentation position of the static presentation file according to the movement speed (or movement distance) and the movement direction.

In the above control device for the electronic apparatus according to the embodiments of the present invention, the displaying of the file content is controlled according to the number of the contact points with the displaying portion by the hand and the movement information of the contact points, so that the displaying of the files can be controlled exactly and conveniently according to the user's intention and the usage experiences of the user is improved efficiently.

For the purpose of convenience and simplicity of the description, it is clear that those skilled in the art can easily understand the particular processes of the device and units therein as described above with reference to the corresponding processes in the embodiments of the method described hereinbefore, and the detailed thereof is omitted.

Those skilled in the art can appreciate that the units and the steps of the algorithm in individual examples described in combination with the embodiments disclosed herein can be implemented in electronic hardware, or the combination of computer software and electronic hardware. Whether the functions are carried out in the form of hardware or in the form of software, it depends on the specific applications of the technical solution and constrains on the design thereof. Those skilled in the art can use different methods to implement the functions as described for each specific application, and such an implementation should not be considered as going beyond the scope of the present invention.

In the embodiments provided in the application, it should be understand that the device and the method as disclosed can be implemented in other manners. For example, the embodiments of the device are only for illustration, e.g., the division of the unit only shows a function division in logic, but in an actual realization, there are other forms of divisions; for example, a plurality of units or components can be combined or can be integrated into another system, or some features can be ignored or are not be carried out.

If the functions are implemented in the function units in software, which is on sale or used as separate products, they can be stored in a computer readable storage medium. Based on the understanding, the solution of the present invention in essence or the part of the present invention contributing to the prior art or a part of the technical solution can be embodied in software products, and the computer software products are stored in a storage medium and comprises several instructions to cause a computing apparatus (can be a personal computer, a server, or a network apparatus or the like) to carry out the entire or partial steps of the methods of the individual embodiments of the present invention.

The above descriptions only illustrate the specific embodiments of the present invention, and the protection scope of the present invention is not limited to this. Given the teaching as disclosed herein, variations or substitutions, which can easily occur to any skilled pertaining to the art, should be covered by the protection scope of the present invention. Thus, the protection scope of the present invention is defined by the claims.

What is claimed is:

1. A control method applied to an electronic apparatus having a touchscreen and executing a file, comprising steps of:
determining whether content in the file is being displayed on the touchscreen;
determining a displaying portion for displaying the file on the touchscreen, when the content in the file is being displayed on the touchscreen;
detecting at an arbitrary position in the displaying portion a gesture information, which comprises a number of contact points of hands with the displaying portion and a movement information of the contact points; and
adjusting the content in the file according to the gesture information.

2. A control method as claimed in claim 1, wherein the file is a stream media file, and the step of adjusting the content in the file according to the gesture information comprises:
dividing adjustment level of the content in the stream media file according to the number of the contact points, wherein an adjustment speed in a high adjustment level is quicker than that in a low adjustment level; and
adjusting the content in the stream media file according to the movement information in the adjustment level corresponding to the number of the contact points.

3. A control method as claimed in claim 2, wherein the movement information comprise a movement direction and one of a movement distance and a movement speed, and the step of adjusting the content in the stream media file according to the movement information comprise:
determining an adjustment direction of the content in the stream media file according the movement direction;
determining an adjustment distance of the content in the stream media file according to one of the movement distance and the movement speed; and
changing the content in the stream media file by the adjustment distance in the adjustment direction.

4. A control method as claimed in claim 1, wherein the file is a static presentation file.

5. A control method as claimed in claim 4, wherein the number of the contact points by a hand with the displaying portion is at least two and the movement information of the contact point comprises the movement direction of the contact point, the step of adjusting the content in the file according to the gesture information comprises:
judging whether the movement directions of the contact points are same;
adjusting a presentation position of the static presentation file when the movement direction of all of the contact points is same, and adjusting a zooming of the static presentation file when the contact points having different movement directions exist among the contact points.

6. A control method as claimed in claim 5, wherein the step of adjusting a presentation position of the static presentation file comprises:
determining the movement distance of the static presentation file according to the number of the contact points; and
changing the presentation position of the static presentation file according to the movement distance.

7. A control method as claimed in claim 5, wherein the step of adjusting a zooming of the static presentation file comprises:
judging whether the contact points having different movement directions move face-to-face or back-to-back; and
zooming out the static presentation file when the contact points having different movement directions move face-to-face and zooming in the static presentation file when the contact points having different movement directions move back-to-back.

8. A control method as claimed in claim 7, wherein the step of zooming in the static presentation file comprises determining a zooming-in times of the static presentation file according to the number of the contact points and zooming in the static presentation file according to the zooming-in times; and
the step of zooming out the static presentation file comprises determining a zooming-out times of the static presentation file according to the number of the contact points and zooming out the static presentation file according to the zooming-out times.

9. A control method as claimed in claim 4, wherein the step of adjusting the content in the file according to the gesture information comprises:
dividing adjustment level of the content in the static presentation file according to the number of the contact points, wherein an adjustment speed in a high adjustment level is quicker than that in a low adjustment level; and
adjusting the presenting position in the static presentation file according to the movement information of the contact points in the adjustment level corresponding to the number of the contact points.

10. A control device applied to an electronic apparatus having a touchscreen and executing a file, comprising:
a determination unit for determining whether content in the file is being displayed on the touchscreen, and determining a displaying portion for displaying the file on the touchscreen when the content in the file is being displayed on the touchscreen;
a detection unit for detecting at an arbitrary position in the displaying portion a gesture information, which comprises the number of contact points of hands with the displaying portion and a movement information of the contact points; and
a control unit for adjusting the content in the file according to the gesture information.

11. A control device as claimed in claim 10, wherein the file is a stream media file, and the control unit comprises:
a dividing section for dividing adjustment level of the content in the stream media file according to the number of the contact points, wherein an adjustment speed in a high adjustment level is quicker than that in a low adjustment level; and
an adjustment section for adjusting the content in the stream media file according to the movement information in the adjustment level corresponding to the number of the contact points.

12. A control device as claimed in claim 11, wherein the movement information comprises a movement direction and one of a movement distance and a movement speed, and the adjustment section adjusts the content in the stream media file by operations of:
determining an adjustment direction of the content in the stream media file according the movement direction;
determining an adjustment distance of the content in the stream media file according to one of the movement distance and the movement speed; and
changing the content in the stream media file by the adjustment distance in the adjustment direction.

13. A control device as claimed in claim 10, wherein the file is a static presentation file.

14. A control device as claimed in claim 13, wherein the number of the contact points by a hand with the displaying portion is at least two and the movement information of the contact point comprises the movement direction of the contact points, the control unit comprises:
a judgment section for judging whether the movement directions of the contact points are same;
a first adjustment section for adjusting a presentation position of the static presentation file when the movement directions of all of the contact points are same; and
a second adjustment section for adjusting a zooming of the static presentation file when the contact points having different movement directions exist among the contact points.

15. A control device as claimed in claim 14, wherein the first adjustment section adjusts a presentation position of the static presentation file by operations of:
determining the movement distance of the static presentation file according to the number of the contact points; and
changing the presentation position of the static presentation file according to the movement distance.

16. A control device as claimed in claim 14, wherein the judgment section further judges whether the contact points having different movement directions move face-to-face or back-to-back, and the second adjustment section adjusts the scaling of the static presentation file by operations of:
determining a zooming-out times of the static presentation file according to the number of the contact points when the contact points having different movement directions move face-to-face, and zooming out the static presentation file according to the zooming-out times; and
determining a zooming-in times of the static presentation file according to the number of the contact points when the contact points having different movement directions move back-to-back, and zooming in the static presentation file according to the zooming-in times.
